(19) United States
(12) Patent Application Publication
(10) Pub. No.: US 2026/0300106 A1
(43) Pub. Date: Oct. 1, 2026

(54) RESTORING SOFT-DELETED CLOUD OBJECTS THAT STORE DEDUPLICATED BACKUP DATA

(71) Applicant: Dell Products L.P., Round Rock, TX (US)

(72) Inventors: Shefali Sharma, San Jose, CA (US); Durga Prasad Thorati, Gilroy, CA (US); Fei Wang, Sunnyvale, CA (US)

(73) Assignee: Dell Products L.P., Round Rock, TX (US)

(21) Appl. No.: 19/092,295

(22) Filed: Mar. 27, 2025

(51) Int. Cl. G06F 11/14

(52) U.S. Cl. CPC G06F 11/1469; G06F 11/1435; G06F 11/1453

(57) ABSTRACT

A system identifies entities, comprising objects and/or a cloud storage bucket that stores the objects, for soft delete protection, which responds to a delete operation for a set of the entities by creating soft delete entities. The system uses segment references that are stored on a local volume and correspond to objects storing deduplicated data segments to generate a list of all valid objects for the cloud storage bucket. The system generates a list of objects currently in the cloud storage bucket by scanning the bucket. The system identifies each object missing from the cloud storage bucket as a missing object by comparing the list of all valid objects for the bucket against the list of objects currently in the bucket. The system restores each missing object to the cloud storage bucket by executing, for each missing object, an undelete operation for the soft delete entities.

### BACKGROUND

A data object may be a set of information that is backed up as a unit. If a software error corrupts a data object, or if erroneous data updates the data object, a data protection administrator may restore the data object to a previous state that does not include the corrupted or erroneous data. A backup/restore application performs a backup operation either occasionally or continuously to enable this restoration, storing a copy of each desired data object state (such as the values of the data object and the embedding of these values in a database's data structures) within dedicated backup files. When the data protection administrator decides to reinstate the data object to a previous state, the data protection administrator specifies the desired previous state by identifying a desired time when the data object was in this previous state, and then instructs the backup/restore application to perform a restore operation to restore a copy of the corresponding backup file(s) for that previous state to the data object.

A data user may backup data in a data center to one or more remote sites, which may be in one or more cloud locations, to have copies of the data available in case of a data center disaster. Cloud-based data storage systems (or on-demand storage systems) may provide various tools that are crucial for enterprise level network clients. For example, clients may rely on such systems for data protection and recovery services that efficiently back up and recover data in the event of data loss to allow business applications to remain in service or quickly come back up to service. As part of the data protection and recovery infrastructure, clients may rely on third-party cloud-based storages to leverage the benefits associated with such systems (or services) such as cost efficiency (e.g., pay-per-use model) and scalability. These cloud-based storages may implement an object-based storage architecture, and accordingly, client data such as backup data may be stored as objects (or data objects). When managing data, clients may store data within both a local (or on-premises) environment as well as the cloud-based object storage.

Such data storage systems include recording media that retain digital information, have evolved towards scalable designs that can grow with customer demand by adding storage and computation as necessary, and typically store redundant information. For example, when creating a copy of an enterprise's email system data which includes 100 instances of the same 1 Megabyte (MB) data file attachment, a data storage system may store all 100 instances of the same 1 MB data file attachment, inefficiently using 100 MB of storage space to store the same 1 MB data file attachment. Data deduplication can eliminate redundant copies of information, which can improve the utilization of data storage systems and lower capital expenditure by reducing the total amount of recording media required to meet the capacity needs of data storage systems. Continuing the previous example, a data deduplication system stores only one instance of the same 1 MB data file attachment and stores small references to the one stored instance for the 99 subsequent instances.

Backup and restore applications, such as Dell's Data Domain Virtual Edition, provide a software-only deduplication appliance that offers data protection for entry and enterprise environments which backup and restore data via a public cloud. A Data Domain Virtual Edition instance can run on standard hardware and existing infrastructure at a customer's premises and/or in a public cloud such as Amazon Web Services, Azure, or Google Cloud Platform. The Data Domain Virtual Edition is fast and simple to download, deploy and configure-as it can be up and running in minutes, and capacity can be easily moved between virtual systems and/or locations and can be purchased in 1 TB increments, thereby allowing users to grow capacity as the business demands it. Although the current disclosure describes Dell's Data Domain Virtual Edition as an example of a data backup and restore system or a backup and restore application, features of the current disclosure are not limited to the use of any data backup and restore system or backup and restore application.

A backup and restore appliance, such as Data Domain Virtual Edition, can run a specialized operating system and file system, such as the Data Domain File System, which is an inline data deduplication file system. As data is received, a Data Domain File System enables breaking the data into variable sized segments, packing a group of segments in a compression region, grouping a number of compression regions together, writing these groups of compression regions as a container to disk, calculating fingerprint signatures for each segment, and mapping each fingerprint to the identifier of the container which stores the corresponding segment data. A container has a metadata section, which stores the meta information of the container, such as the number of compression regions, the number of segments, the fingerprint of each segment, and so on, and then the metadata section is followed by several data sections, which store the compression regions. Although the current disclosure describes Dell's Data Domain File System as an example of a data file system or an operating system, features of the current disclosure are not limited to the use of any file system.

When user files are backed up on a backup and restore appliance running in a public cloud, the files will be processed by a specialized file system's deduplication engine so that deduplicated data is stored on the public cloud object storage in units referred to as objects. These objects are stored in a logical construct referred to as a bucket or a container in public clouds. Some files systems, such as the Data Domain File System, currently have a data invulnerability architecture which does end to end checksum verification for reads and writes. Such file systems have the capability to do inline error detection and correction for read operations if a corruption is detected, and may also have provisions to do periodic scrubbing operation to detect and repair data corruptions.

For some backup and restore appliances, such as the Data Domain Virtual Edition, the user data is stored in public cloud storage (outside of the backup and restore appliance's compute instance) which makes the data objects vulnerable to possible unauthorized access and deletion. While public clouds provide various mechanisms to restrict access of the object storage to specific compute instances (such as a specific backup and restore appliance) there is a possibility that these objects can get deleted accidentally via a manual operation, a clean-up script(s), a lifecycle policy, or through malicious intrusion activity. Since current data invulnerability architectures cannot recover file systems from this situation, the file system will stop executing correctly and potentially result in data loss for the customer.

Currently, one of the few approaches that a customer typically uses is to protect their data from disaster recovery in a public cloud by replicating their data to a different region in the public cloud. This involves a huge cost for the customer as they will have to pay for additional compute, storage, and network usage for operating the replication target in another region. But even with cross region replication set up, if the objects or a container is deleted from the source backup and restore application which deduplicates data, replication itself may not be able to continue.

### BRIEF DESCRIPTION OF THE DRAWINGS

FIG. 1 illustrates a block diagram of an example of an active tier on object storage architecture for restoring soft-deleted cloud objects which store deduplicated backup data, under an embodiment;

FIG. 2 illustrates a block diagram of an example of a user file segment tree for restoring soft-deleted cloud objects which store deduplicated backup data, under an embodiment;

FIG. 3 illustrates a block diagram of an example of metadata-separated file system architecture for restoring soft-deleted cloud objects which store deduplicated backup data, under an embodiment;

FIG. 4 illustrates a block diagram of an example prime segment architecture tree for restoring soft-deleted cloud objects which store deduplicated backup data, under an embodiment;

FIG. 5 illustrates a block diagram of an example of an object deletion operation for restoring soft-deleted cloud objects which store deduplicated backup data, under an embodiment;

FIG. 6 illustrates a block diagram of an example of an undelete object operation and recovery process for restoring soft-deleted cloud objects which store deduplicated backup data, under an embodiment;

FIGS. 7A-D illustrate block diagrams of an example of deletion and un-deletion sequences for objects and containers for restoring soft-deleted cloud objects which store deduplicated backup data, under an embodiment;

FIG. 8 illustrates a block diagram of an example of a delete object operation which precedes a delete container operation for restoring soft-deleted cloud objects which store deduplicated backup data, under an embodiment;

FIG. 9 illustrates a block diagram of an example of an undelete container operation which is followed by an undelete object operation for restoring soft-deleted cloud objects which store deduplicated backup data, under an embodiment;

FIG. 10 illustrates a block diagram of an example of an undelete object operation which follows an undelete container operation for restoring soft-deleted cloud objects which store deduplicated backup data under an embodiment;

FIG. 11 illustrates a block diagram of an example of an undelete only container operation for restoring soft-deleted cloud objects which store deduplicated backup data, under an embodiment;

FIG. 12 illustrates a block diagram of an example system which restores soft-deleted cloud objects which store deduplicated backup data, under an embodiment;

FIG. 13 is a flowchart that illustrates an example method which restores soft-deleted cloud objects which store deduplicated backup data, under an embodiment; and

FIG. 14 is a block diagram illustrating an example hardware device in which the subject matter may be implemented.

### DETAILED DESCRIPTION

For backup and restore applications which deduplicate data in a public cloud, if either the file system's data in the cloud object storage bucket or the bucket itself is deleted without authorization, the current data invulnerability architecture cannot recover the file system's data in these scenarios. A system executes a method that enhances a file system's data invulnerability by recovering and restoring the file system in the situation where the file system's user data objects stored in a public cloud storage bucket are deleted or the whole public cloud storage bucket containing these user data objects gets deleted. The metadata-separated file system architecture is leveraged along with a soft delete feature offered by most public clouds providers to identify and restore the user data objects that have been deleted, perform a file system integrity check, and bring up the file system, after which the user data is fully recovered and its integrity is maintained.

Embodiments restore soft-deleted cloud objects which store deduplicated backup data. A system identifies entities, which comprise objects and/or a cloud storage bucket that stores the objects, for soft delete protection, which responds to a delete operation for a set of the entities by creating soft delete entities. The system uses segment references, stored on a local volume, which correspond to objects storing deduplicated data segments, to generate a list of all valid objects for the cloud storage bucket. The system generates a list of objects currently in the cloud storage bucket by scanning the cloud storage bucket. The system identifies each object which is missing from the cloud storage bucket as a missing object by comparing the list of all valid objects for the cloud storage bucket against the list of objects currently in the cloud storage bucket. The system restores each missing object to the cloud storage bucket by executing, for each missing object, an undelete operation for the soft delete entities.

For example, a system identifies specific data objects #1, #2, #3, and #4 for soft delete protection, which subsequently responds to unauthorized delete operations on objects #2 and #4, in a cloud object storage bucket ABC, by creating soft-deleted objects #2 and #4. The system uses segment references metadata, stored on local volumes, which corresponds to objects #1, #2, #3, and #4, which store deduplicated data segments A, B, C, D, E, F, and G, to generate a list of all the valid objects #1, #2, #3, and #4 for the cloud object storage bucket ABC. The system generates a list of objects #1 and #3 currently in the cloud object storage bucket ABC by executing the list objects operation on the cloud object storage bucket ABC. The system identifies the object #2 and the object #4 which are missing from the list of objects currently in the cloud object storage bucket ABC. The system executes undelete operations on the soft-deleted entities for the object #2 and the object #4, which restore the previously missing object #2 and the previously missing object #4 to the cloud object storage bucket ABC.

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Although these embodiments are described in sufficient detail to enable one skilled in the art to practice the disclosed embodiments, it is understood that these examples are not limiting, such that other embodiments may be used, and changes may be made without departing from their spirit and scope. For example, the operations of methods shown and described herein are not necessarily performed in the order indicated and may be performed in parallel. It should also be understood that the methods may include more or fewer operations than are indicated. In some embodiments, operations described herein as separate operations may be combined. Conversely, what may be described herein as a single operation may be implemented in multiple operations.

Reference in the specification to “one embodiment” or “an embodiment” or “some embodiments,” means that a particular feature, structure, or characteristic described in conjunction with the embodiment may be included in at least one embodiment of the disclosure. The appearances of the phrase “an embodiment” or “the embodiment” in various places in the specification do not necessarily all refer to the same embodiment.

The following sections provides a high-level introduction of a metadata-separated file system architecture for an active tier on a data object storage system, and the concept of a soft delete feature available in most public clouds. Then the soft delete feature is combined with the file system architecture to provide a new solution for enhancing the data invulnerability of backup and restore appliances that deduplicate data in the event of losing file system data stored in a public cloud storage bucket/container.

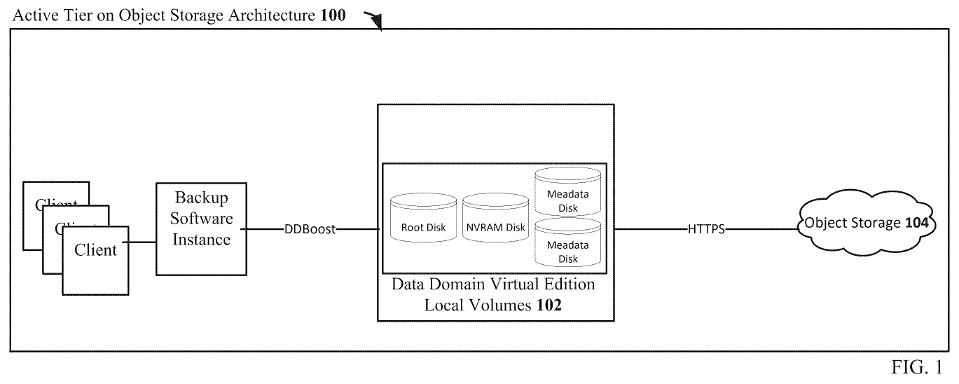

FIG. 1 illustrates a block diagram of an example of an active tier on object storage architecture for restoring soft-deleted cloud objects which store deduplicated backup data, under an embodiment. The active tier on the object storage architecture 100 can be used by a software-only protection storage appliance, such as the Data Domain Virtual Edition, which is a virtual deduplication appliance that provides cost-optimized data protection for entry, enterprise and service provider environments, and which may store the file system metadata on locally attached block storage volumes 102 and the file system's user data on the cloud object storage buckets/containers 104. User files are backed up as a continuous stream of data that is broken into segments. A hash of each segment may be referred to as a fingerprint, which can be computed to create a segment reference for a data segment.

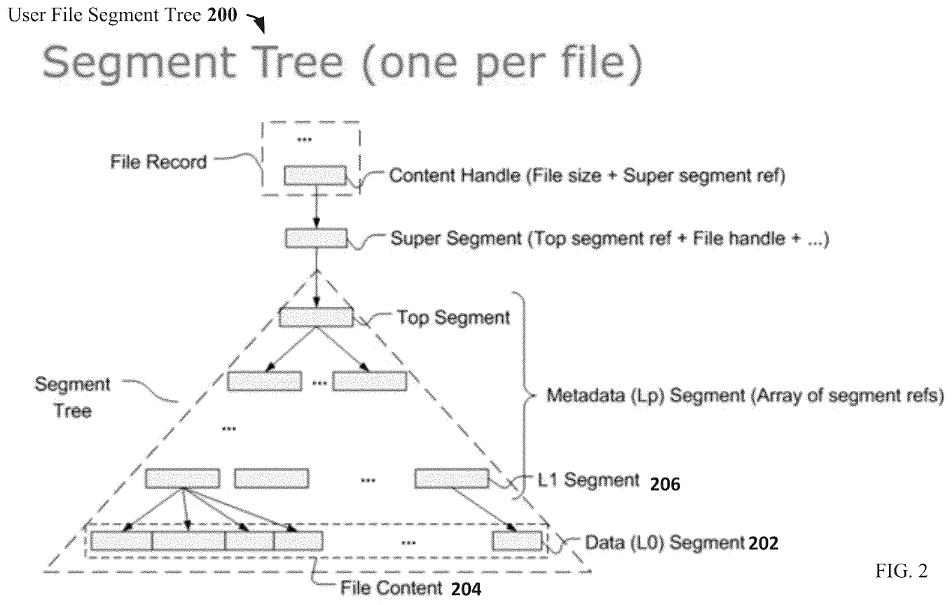

FIG. 2 illustrates a block diagram of an example of a user file segment tree for restoring soft-deleted cloud objects which store deduplicated backup data, under an embodiment. The user file includes data segments that are compressed and packed into data structures called containers. The hierarchical user file segment tree 200 contains the LO segments 202, which contain the actual file content 204, L1 segments 206 which contain the segment references to the L0 segments, L2 segments, which contain the segment references to the L1 segments, and so on, up to the LP segments, which have the hierarchical segment references to the L0 segments and can be stored in the metadata (meta) containers.

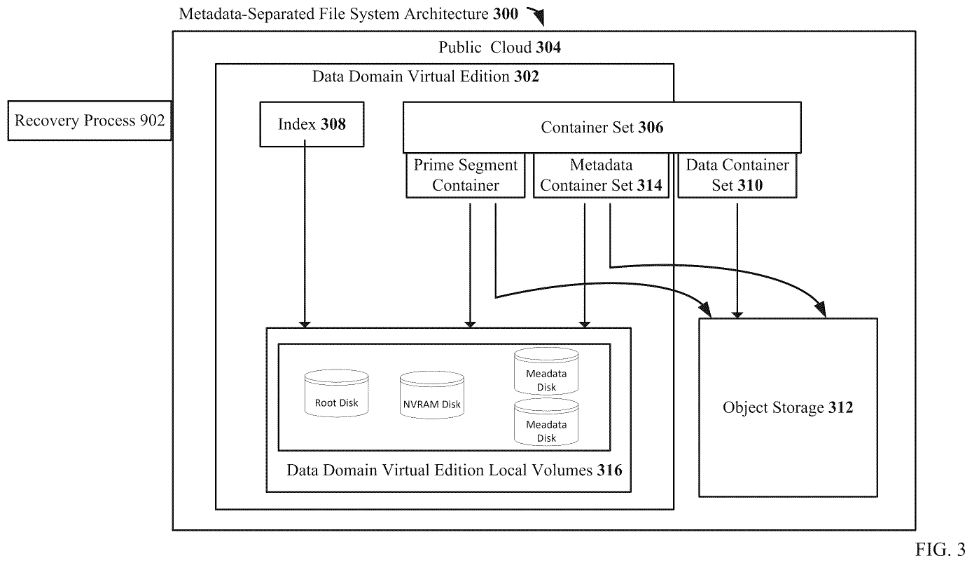

FIG. 3 illustrates a block diagram of an example of metadata-separated file system architecture for restoring soft-deleted cloud objects which store deduplicated backup data, under an embodiment. The metadata-separated file system architecture 300 is for a backup and restore appliance 302 in a public cloud 304. A set of containers may be referred to as a container set 306 or a CSET. File systems, such as the data domain file system, may use a data structure called an index 308 to map fingerprints of the data segments to their corresponding containers. The index 308 is referenced to decide if a newly arrived data segment from a user file has been previously stored or is unique, by comparing the newly arrived data segment's fingerprint with the existing fingerprints in the index.

For a software-only protection storage appliance, such as the Data Domain Virtual Edition 302 in the public cloud 304, for each user file the actual data segments are packed into a data container set 310, which are backed on object storage 312. A metadata container set 314 has the references needed to access the individual data segments in the data containers and these references may be stored on the local volumes 316 attached to the instance of the Data Domain Virtual Edition. The metadata container set 314 can be mirrored on the object storage 312 for redundancy.

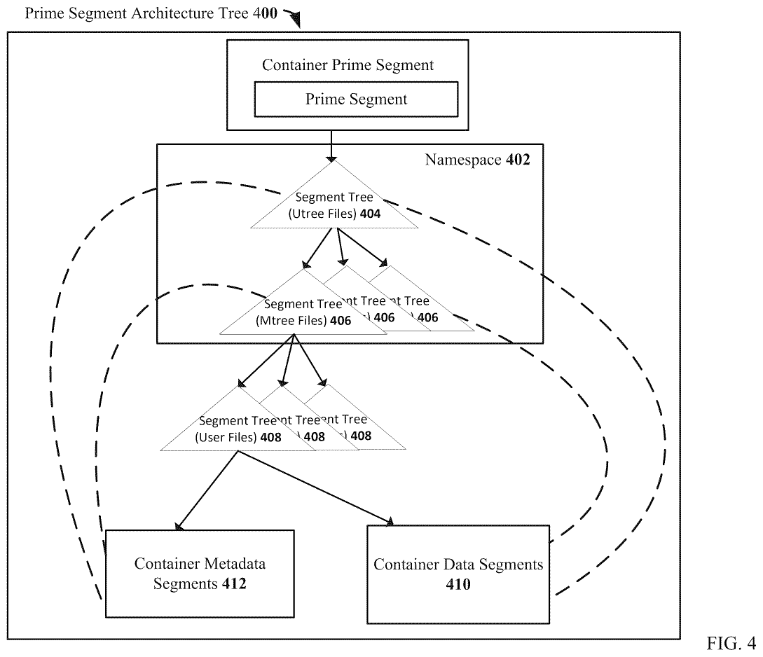

FIG. 4 illustrates a block diagram of an example prime segment architecture tree for restoring soft-deleted cloud objects which store deduplicated backup data, under an embodiment. The prime segment architecture tree 400 may include a special segment which references the namespace 402 file of the deduplication domain, represented by a utree 404. The utree 404 has references for each of the Mtrees 406, which are a unit of management for applying policies on a group of user files. A user file is represented by a segment tree 408 containing the data segments 410 and the metadata segments 412. Therefore, through a prime segment, a system can access the segment references of every user file in the deduplication namespace 402.

A prime segment container may be stored on a local volume and mirrored on object storage, which enables a file system to traverse the segment references (for all the user files) from local volumes and identify the data containers in the cloud storing the segments corresponding to those user files. An object corresponding to each of these containers should be stored in object storage. If any of the valid containers is deleted without authorization, and is therefore missing on object storage, the file system could stop functioning correctly.

A soft delete feature is similar to the recycle bin option in personal computers. If enabled, the soft delete feature allows retention of deleted entities such as objects or containers of objects for a specific (user defined) period. During this time, it is possible to “undelete” a soft-deleted object or container and restore the undeleted object or container back to its original location. After its retention period expires, a soft deleted object or container will be permanently deleted. Most cloud provider supports a soft delete feature.

Although this feature is available in all public clouds, this disclosure uses Azure as an example. The Azure blob object storage is Microsoft's object storage solution for the public cloud. The Azur blob object storage offers three types of resources-storage accounts, object storage containers, and blob objects. An Azure storage account stores Azure data objects: blobs, files, queues, and tables.

A storage account provides a unique namespace in Azure for all data objects. The combination of an account name and a blob object storage endpoint forms the base address for the blob objects in a storage account. Object storage containers are the logical construct under Azure storage accounts for storing data objects. An Azure object storage container, called an object storge bucket in most public clouds. organizes a set of blob objects, similar to a directory in a file system. A backup and restore appliance, such as the Data Domain Virtual Edition running in an Azure cloud, can make use of the storage account and object storage containers to store the blob data objects.

In an Azure cloud, the soft delete feature may be enabled at a blob object or an object storage container granularity. Blob object soft delete protects an individual blob object, snapshot, or version from unauthorized deletes or overwrites by maintaining the deleted data in the system for a specified period. During the retention period, the soft-deleted object can be restored to its state at the time it was deleted by calling an undelete operation, which may be referred to as an undelete object operation. After the retention period has expired, if the soft-deleted object has not been restored, then the object is permanently deleted.

Container soft delete protects a container's data from unauthorized deletions by maintaining the deleted data in the system for a specified period. During the retention period, a soft deleted container and its contents can be restored to the container's state at the time it was deleted by calling an undelete operation, which may be referred to as an undelete container operation. After the retention period has expired, if the soft-deleted container has not been restored, then the container and its contents are permanently deleted.

A system can execute a method that recovers a file system in different scenarios by leveraging the soft delete feature for objects and cloud object storage buckets into the metadata-separated file system architecture that stores metadata on local volumes, which is mirrored on cloud object storage, where the deduplicated file system data is stored for a backup and restore appliance. One scenario is the consequence of an unauthorized deletion of individual live objects from a storage account's cloud object storage bucket, which results in a file system encountering an error message about the individual live object not existing when attempting to read such an object. The file system halts, and initiates a recovery process to identify and recover any missing objects, perform a file system integrity check, and then return the file system to normal operations. To successfully execute this recovery process, it is mandatory to enable the soft delete feature for the objects to be protected before encountering the missing object condition. Also, the recovery process needs to be attempted before the soft delete restoration window for the specific protected objects expires.

The sequence of events and the file system recovery steps for this scenario are described by the following examples. An operation initiator invokes an unauthorized delete operation on at least one object in a cloud object storage bucket, which may be referred to as a delete object operation. If the soft delete protection has been enabled for any specific objects, the deletion of any of these specific objects will create corresponding soft deleted objects in the soft deleted entities until the soft delete retention period expires for the specific objects. The file system detects the missing objects and initiates the recovery process to bring up the file system.

An operation initiator can be a person who manually invokes a delete operation or a computer instruction such as a script which is executed and invokes a delete operation. An operation initiator may be authorized or unauthorized to delete objects and/or a container. An operation initiator may invoke a delete operation that is either malicious or accidental.

Using the metadata container set's segment references on the backup and restore application's local volumes, the system generates a reference list of all the valid objects that should be in the cloud object storage bucket. Then the system scans the cloud object storage bucket for a list of objects that the cloud object storage bucket currently stores, and computes the difference in object reference lists from the local volume versus the object reference list from the cloud object storage bucket. Next, the system identifies a list of objects that are missing from the cloud object storage bucket, based on the objects in the local volume reference list for which the list objects operation fails.

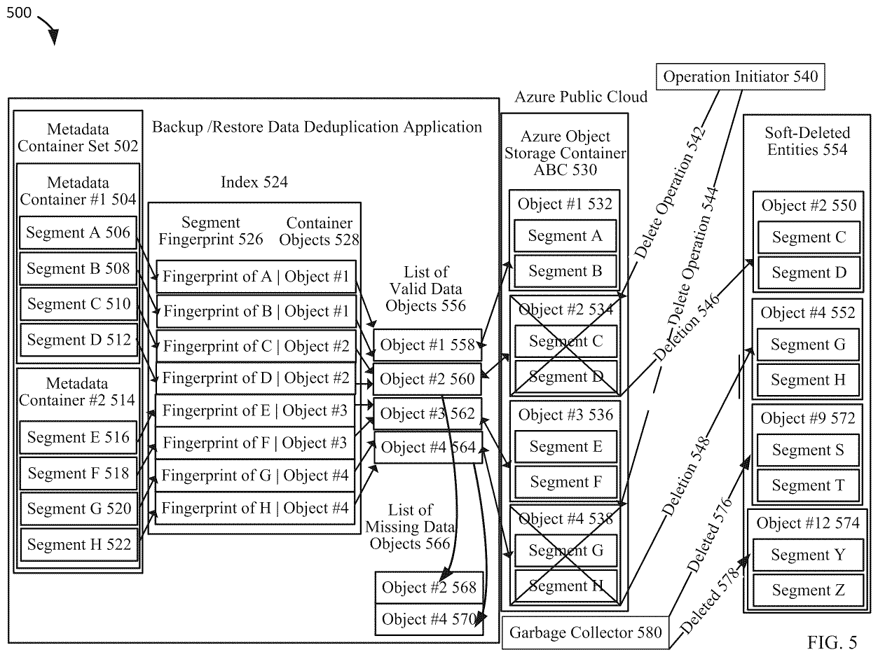

FIG. 5 illustrates a block diagram of an example of an object deletion operation for restoring soft-deleted cloud objects which store deduplicated backup data, under an embodiment. The metadata container set 502 includes the metadata container #1 504 which stores references for the segment A 506, the segment B 508, the segment C 510, and the segment D 512, while the metadata container #2 514 has references for the segment E 516, the segment F 518, the segment G 520, and the segment H 522. The index 524 contains the mapping of the segment fingerprints 526 to the file system's container objects 528, which store copies of the segments 506-512 and 516-522.

The Azure object storage container ABC 530 contains the object #1 532, the object #2 534, the object #3 536, and the object #4 538, An operation initiator 540 invokes an unauthorized delete operation 542 on the object #2 534, which may be referred to as a delete object operation, and invokes the unauthorized delete operation 544 on the object #4 538, which may be referred to as a delete object operation, in the Azure object storage container ABC 530.

The deletion 546 of the valid object #2 534 and the deletion 548 of the valid object #4 538 now results in the creation of the soft-deleted object #2 550 and the soft deleted object #4 552 in the soft-deleted entities 554 in the Azure infrastructure.

The file system will detect the missing objects, and initiate the recovery process. For each of the segments 506-512 and 516-522 in the metadata container #1 504 and in the metadata container #2 514, the index 524 will be referenced to identify the corresponding container object 528 which stores the segments 506-512 and 516-522. That will generate the required list of valid objects 556, which includes object #1 558, the object #2 560, the object #3 562, and the object #4 564, which should be currently stored in the Azure object storage container ABC 530.

For the set of these objects #1 558-#4 564, a list objects operation may be invoked to identify the objects #1 558-#4 564 which are actually currently stored in the Azure object storage container ABC 530. The list objects operation succeeds for the object #1 558 and the object #3 562, but fails for the deleted object #2 560 and the deleted object #4 564. Comparing the list of the required valid objects 556 with the list of the objects for which list object operation failed, the deleted object #2 560 and the deleted object #4 564, provides the list of the missing objects 566, which include the missing object #2 568 and the missing object #4 570.

On backup and restore appliances, the segments corresponding to the user files which have been deleted or modified and are not being referenced in any segment tree are cleaned up by a process which may be referred to as garbage collection. The garbage collection process copies the live segments from a file system's old container to a new container and then deletes the old container. Since the soft delete feature has been enabled on object storage granularity, the soft deleted objects can also have the objects deleted by the garbage collection process in addition to the unauthorized deletion operations. Therefore, the system 500 may confirm that the object #9 572 and the object #12 574 which were intentionally deleted 576 and 578 by the garbage collector 580 are not restored.

For each of the missing object compiled in the list of missing objects, the system verifies that the missing object exists as a soft deleted object, and then executes an undelete operation, which may be referred to as an undelete object operation, which restores the soft deleted objects to the cloud object storage bucket. After all missing objects have been restored by any required undelete operations, which may be referred to as all undelete object operations, the list objects operation now succeeds for all the previously missing objects. The list of required valid objects, which was generated from the segment references metadata stored in the local volumes, now matches with the scanned objects currently in the cloud object storage bucket, such that a file system integrity check can now be performed. Once the file system integrity check completes successfully, the system can proceed with restarting the file system, thereby completing the recovery process.

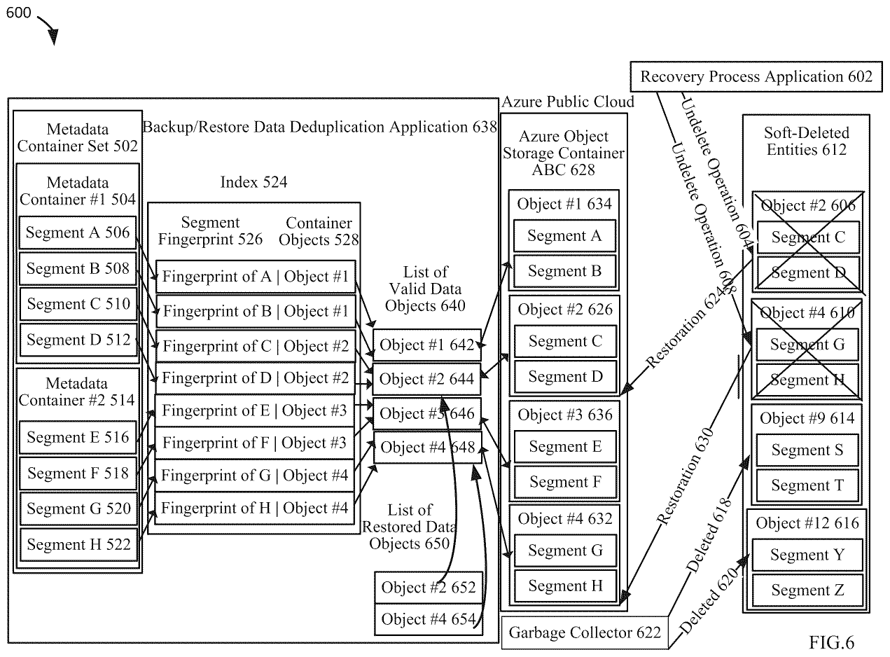

FIG. 6 illustrates a block diagram of an example of an undelete object operation and recovery process for restoring soft-deleted cloud objects which store deduplicated backup data, under an embodiment. In this example, the recovery process application 602 invokes the undelete operation 604, which may be referred to as an undelete object operation, for the object #2 606, and invokes the undelete operation 608, which may be referred to as an undelete object operation, for the object #4 610, which were valid file system objects that had been previously deleted and are present in the list of soft deleted entities 612. The object #9 614 and the object #12 616, which are also in the list of soft-deleted entities 612, are ignored and not considered for restoration because they were intentionally deleted 618 and 620 by the garbage collector 622.

The undelete operation 604, which may be referred to as an undelete object operation, results in a restoration 624 of the object #2 626 in the Azure object storage container ABC 628, and the undelete operation 608, which may be referred to as an undelete object operation, results in the restoration 630 of the object #4 632 in the Azure object storage container ABC 628, which already stores the object #1 634 and the object #3 636. Now the backup and restore application 638 can succeed using the list objects operation for the object #2 626 and the object #4 632.

The list of valid data objects 640 generated from the metadata includes the object #1 642, the object #2 644, the object #3 646, and the object #4 648, and therefore now collectively matches with the list of the scanned objects #1-#4 currently in the Azure object storage container ABC 628. Since the previous list of missing data objects has now become the list of restored data objects 650, which includes the restored object #2 652 and the restored object #4 654, the file system integrity check can now be performed. Once that file system integrity check completes execution, the file system can come up on the backup and restore data duplication application 638, thereby completing the recovery process. FIG. 6 depicts the elements 502-528, which are substantially similar to the elements 502-528 depicted in FIG. 5.

A different scenario requires restoring the file system when unauthorized deletion operations delete both objects and a cloud object storage bucket. This approach would be taken if individual objects which were stored in the cloud object storage bucket have been deleted followed by the deletion of the cloud object storage bucket that had been storing those objects.

When a file system tries to access the cloud object storage bucket, it will get an error message about the cloud object storage bucket not existing. The file system halts, and initiates a recovery process to identify and recover the missing cloud object storage bucket, and then to identify and recover the objects deleted prior to the deletion of the cloud object storage bucket, perform and complete a file system integrity check, bring up the file system, and then proceed with restarting the file system, thereby completing the recovery process.

If a cloud object storage bucket is protected by enabling a soft delete feature and then is subsequently deleted, executing an undelete operation, which may be referred to as an undelete container operation, restores the cloud object storage bucket along with its contents. But if some objects had been deleted first from the cloud object storage bucket and then the cloud object storage bucket was deleted, the recovery process will have to first undelete the cloud object storage bucket and then undelete the objects which were deleted prior to the deletion of the cloud object storage bucket. The reason for this two-step restoration process is that the undelete operation, which may be referred to as an undelete container operation, would only restore the cloud object storage bucket and the objects which the cloud object storage bucket stored at the time of the deletion of the cloud object storage bucket.

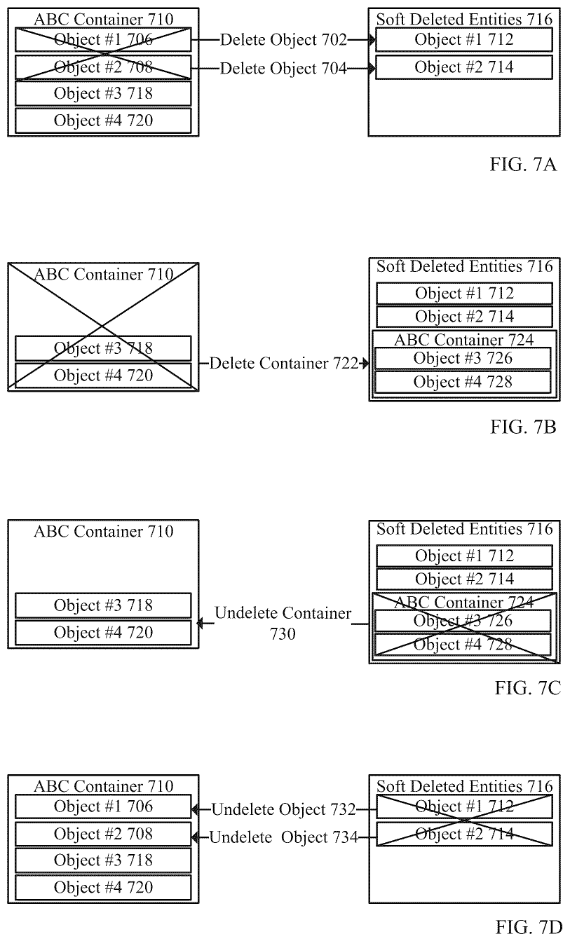

In order to restore the objects deleted prior to the deletion of the cloud object storage bucket, the deleted objects should have the soft delete protection for these objects before any of these objects were deleted. Then the undelete operations, which may be referred to as the undelete object operations, need to be invoked on these objects to restore them back to the cloud object storage bucket. This soft delete behavior for an Azure object storage container ABC is explained below in reference to FIGS. 7A-D.

FIGS. 7 A, B, C, and D illustrate block diagrams of an example of deletion and un-deletion sequences for objects and containers for restoring soft-deleted cloud objects which store deduplicated backup data, under an embodiment. These examples depict how a soft delete feature for object storage containers functions in an Azure cloud, using an Azure object storage container ABC with four data objects, the object #1 through the object #4. FIG. 7A depicts that the unauthorized delete object 702 operation and the unauthorized delete object 704 operation deleted the object #1 706 and the object #2 708 from the ABC container 710 for object storage. The deleted object #1 712 and the deleted object #2 714 s exist as soft deleted entities 716, and the ABC container 710 for object storage is left with only the object #3 718 and the object #4 720.

Next, FIG. 7B depicts that the ABC container 710 for object storage is deleted by the unauthorized delete container 722 operation, and the ABC container 710 continues to exists as the deleted ABC container 724 that stores the deleted object #3 726 and the deleted object #4 728 in the soft deleted entities 716. Then FIG. 7C depicts that the ABC container 710 for object storage is restored using the undelete container 730 operation. But after this restoration, the ABC container 710 for object storage only contains the object #3 718 and the object #4 720. Since the object #1 706 and the object #2 708 were deleted before the ABC container 710 for object storage was deleted, the previously deleted object #1 712 and the previously deleted object #2 714 were not automatically restored by the undelete operation 730 for the ABC container 710. Consequently, FIG. 7D depicts that the undelete object 732 operation and the undelete object 734 operation need to be invoked on the previously deleted object #1 712 and the previously deleted object #2 714, respectively, in the soft-deleted entities 716 to restore the object #1 706 and the object #2 708 into the ABC container 710.

To successfully execute this recovery process, it is mandatory to enable the soft delete feature for specific objects as well as the container before any of the specific objects or the container is deleted. Also, the recovery process needs to be attempted before the soft delete restoration window for the objects or the container expires.

The sequence of events and the file system recovery steps for this scenario are described by the following examples. An operation initiator invokes an unauthorized delete operation, which may be referred to as a delete object operation, on at least one object in the Azure object storage container ABC. If soft delete protection has been enabled for any specific object, any deletion of the specific objects will create a soft deleted object in the soft deleted entities until the specific object's soft delete retention period expires. An operation initiator then invokes an unauthorized delete operation, which may be referred to as a delete container operation, on the Azure object storage container ABC. If soft delete protection has been enabled for the container, the deletion of the Azure object storage container ABC will create a soft-deleted entity for the deleted container in the soft deleted entities until the soft delete retention period expires.

The file system detects the missing container and initiates the recovery process to bring up the file system. Using the metadata container set's segment references on the backup and restore application's local volumes, the system generates a reference list for all the valid objects that should be currently stored in the Azure object storage container ABC.

The system restores the deleted Azure object storage container ABC by executing an undelete operation for the Azure object storage container ABC in the soft-deleted entities. Then the system scans the restored Azure object storage container ABC for the list of objects that restored the container ABC actually currently stores, and computes the difference in object reference lists from the local volume versus the object reference list from the restored Azure object storage container ABC. Next, the system identifies a list of objects that are missing from the restored Azure object storage container ABC, based on the objects in the local volume reference list for which the list object operation fails.

The file system restores the missing objects to the restored container by executing an undelete operation for the soft-deleted entities for each missing object to complete es the recovery process to bring up the file system. Using the reference list generated from the metadata container set's segment references on the backup and restore application's local volumes, the system confirms that all the valid objects that should be currently stored in the restored Azure object storage container ABC are actually stored in the restored container.

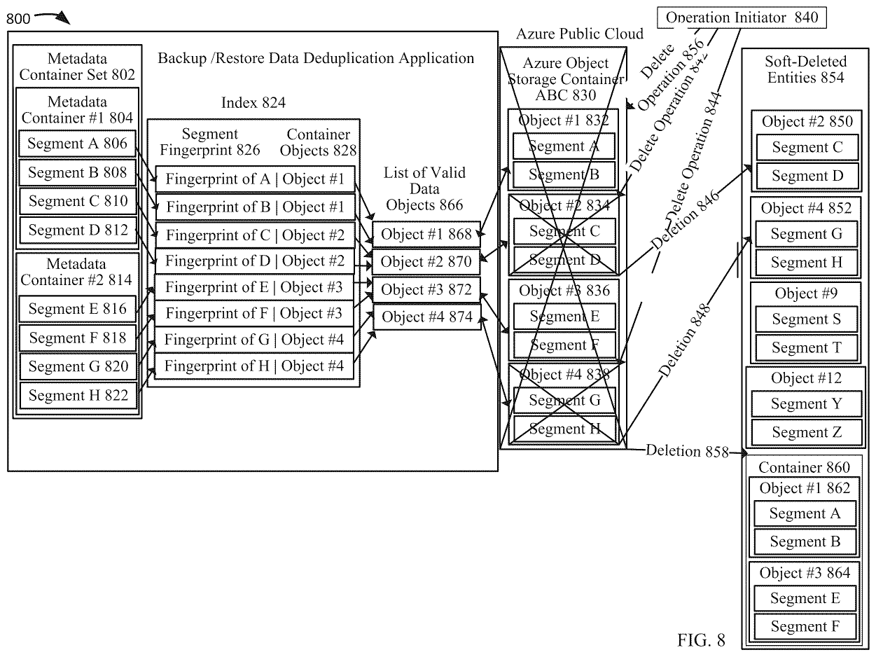

FIG. 8 illustrates a block diagram of an example of a delete object operation which precedes a delete container operation for restoring soft-deleted cloud objects which store deduplicated backup data, under an embodiment. The example containers sets and objects, in which the metadata container set 802 includes the metadata container #1 804, which has references for the segment A 806, the segment B 808, the segment C 810, and the segment D 812, while the metadata container #2 814 has references for the segment E 816, the segment F 818, the segment G 820, and the segment H 822. The index 824 contains the mapping of the segment fingerprints 826 to the file system's container objects 828 that store the segments 806 812 and 816-822. The Azure object storage container ABC 830 includes the object #1 832, the object #2 834, the object #3 836, and the object #4 838. An operation initiator 840 invokes the unauthorized delete operation 842, which may be referred to as a delete object operation, on the object #2 834 and an unauthorized delete operation 844, which may be referred to as a delete object operation, on the object #4 838 in the Azure object storage container ABC 830. The deletion 846 of the valid object #2 834 and the deletion 848 of the valid object #4 838 now results in the existence of the soft-deleted object #2 850 and the soft deleted object #4 852 in the soft-deleted entities 854 in the Azure infrastructure.

Then an operation initiator, which might be the operation initiator 840 or a different operation initiator, invokes an unauthorized delete operation 856, which may be referred to as a delete container operation, on the Azure object storage container ABC 830. The deletion 858 of the Azure object storage container ABC 830 now results in the existence of a soft-deleted container 860, which contains the soft-deleted object #1 862 and the soft-deleted object #2 864, in the soft-deleted entities 854 in the Azure infrastructure. The file system will detect the missing container, and initiate the recovery process. For each of the segments 806-812 and 816-822 in the metadata container #1 804 and in the metadata container #2 814, the index 824 will be referenced to identify the corresponding container objects 828 containing the segments 806 812 and 816-822. That will generate the required list of valid data objects 866, which includes the object #1 868, the object #2 870, the object #3 872, and the object #4 874, which should be currently stored in the Azure object storage container ABC 830.

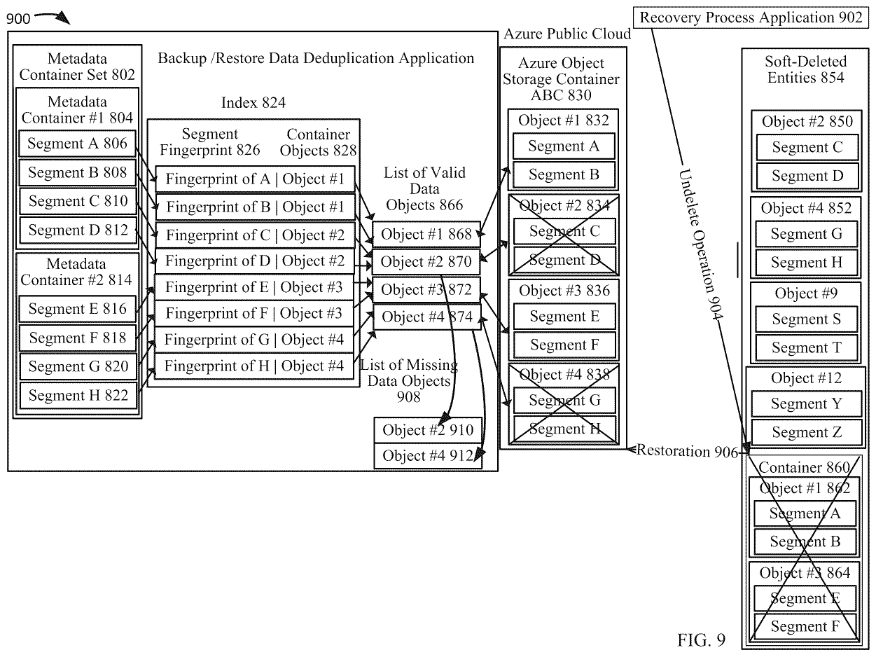

FIG. 9 illustrates a block diagram of an example of an undelete container operation which is followed by an undelete object operation for restoring soft-deleted cloud objects which store deduplicated backup data, under an embodiment. An example recovery process application 902 verifies that the deleted Azure object storage container ABC 830 exists as the soft-deleted container 860 in the soft deleted entities 854. The recovery process application 902 invokes an undelete operation 904, which may be referred to as an undelete container operation, which restores 906 the Azure object storage container ABC 830 and its contents to the same state as at the time of deletion. The undelete operation 904, which may be referred to as an undelete container operation, will only restore 906 the objects that the Azure object storage container ABC 830 stored at the time of deletion.

The recovery process application 902 can invoke a list object operation to identify if the objects #1 868-#4 874 which should be stored in the restored Azure object storage container ABC 830 are currently present in the restored Azure object storage container ABC 830. If the list of valid data objects 866 which are required and generated from the metadata from local volumes does not match with the objects currently stored in the restored Azure object storage container ABC 830, that implies some objects must have been deleted from the Azure object storage container ABC 830 prior to its deletion. In this example, a list objects operation succeeds for the object #1 868 and the object #3 872, but fails for the previously deleted object #2 870 and the previously deleted object #4 874. Comparing the list of the valid data objects 866 which are required against the list of the objects for which list object operation failed, the previously deleted object #2 870 and the previously deleted object #4 874, provide the list of the missing objects 908, which include the missing object #2 910 and the missing object #4 912. FIG. 9 depicts the elements 802-874, which are substantially similar to the elements 802-874 depicted in FIG. 8.

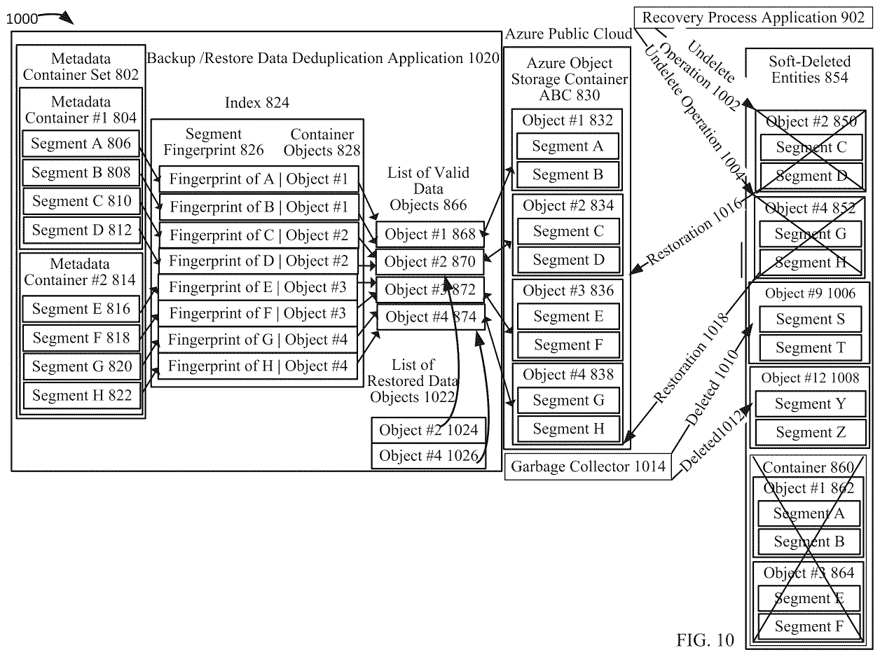

FIG. 10 illustrates a block diagram of an example of an undelete object operation which follows an undelete container operation for restoring soft-deleted cloud objects which store deduplicated backup data under an embodiment. For each of the missing objects in the list of the missing objects 908, which include the missing object #2 910 and the missing object #4 912, the recovery process application 902 verifies that these missing objects exist as the soft deleted object #2 850 and the soft-deleted object #4 852. The recovery process application 902 invokes the undelete operation 1002, which may be referred to as an undelete object operation, for the object #2 850 and the undelete operation 1004, which may be referred to as an undelete object operation, for the object #4 852, which were valid file system objects that had been previously deleted and are present in the list of soft deleted entities 854.

The object #9 1006 and the object #12 1008, which are also in the list of soft-deleted entities 854, are ignored and not considered for restoration because they were intentionally deleted 1010 and 1012 by the garbage collector 1014. The undelete operation 1002, which may be referred to as an undelete object operation, results in the restoration 1016 of the object #2 834 in the Azure object storage container ABC 830, and the undelete operation 1004, which may be referred to as an undelete object operation, results in the restoration 1018 of the object #4 838 in the Azure object storage container ABC 830, which already stores the object #1 832 and the object #3 836. Now the backup and restore application 1020 can succeed using the list object operation for the object #2 834 and the object #4 838.

The list of valid data objects 866 generated from the metadata already included the object #1 868 and the object #3 872, and therefore now collectively matches with the list of the scanned objects 1-4 currently in the Azure object storage container ABC 830. Since the list of missing data objects 908 has now become a list of restored data objects 1022, which includes the restored object #2 1024 and the restored object #4 1026, the file system integrity check can now be performed. Once file system integrity check completes, then the file system can come up on the backup and restore application 1020, thereby completing the recovery process. FIG. 10 depicts the elements 802-874, which are substantially similar to the elements 802-874 depicted in FIG. 8, and depicts the elements 902-912, which are substantially similar to the elements 902-912 depicted in FIG. 9.

After all the missing objects have been restored by the undelete operations, which may be referred to as the undelete object operations, the list objects operation now succeeds for all the previously missing objects. The list of valid data objects in the metadata from local volumes matches with the objects in the Azure object storage container ABC and the file system integrity check can now be performed. Once the file system integrity check completes successfully, the file system can be restarted, thereby completing the recovery process.

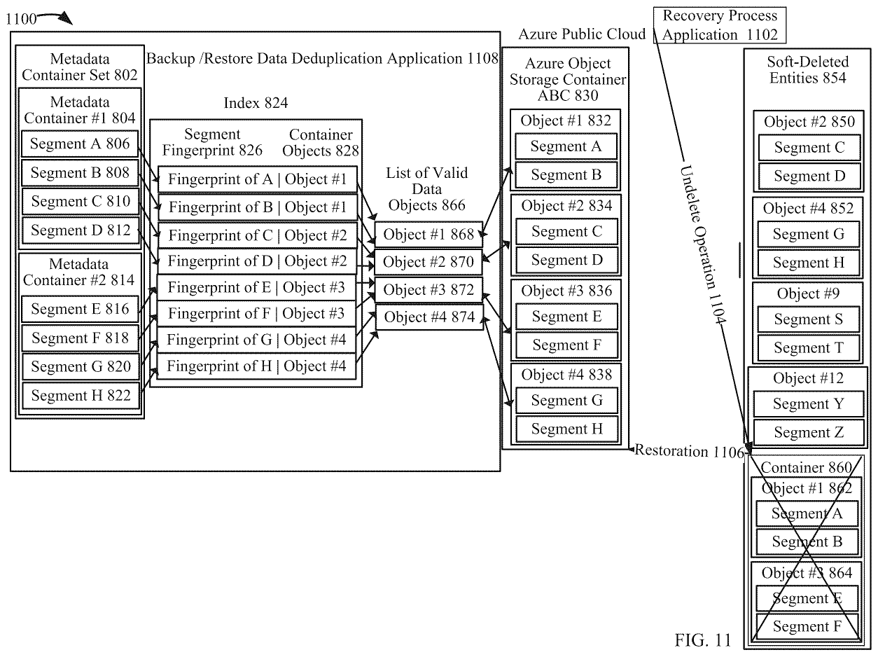

If an operation initiator had invoked an unauthorized delete operation, which may be referred to as a delete container operation, on the Azure object storage container ABC without deleting any of the valid objects prior to the container deletion, the simplified file system recovery process in that case would be as described in the example below. FIG. 11 illustrates a block diagram of an example of an undelete only container operation for restoring soft-deleted cloud objects which store deduplicated backup data, under an embodiment. After an operation initiator invoked an unauthorized delete operation, which may be referred to as a delete container operation, on the Azure object storage container ABC 830, the file system detected the missing container, and initiated the recovery process. For each of the segments 806-812 and 816-822 in the metadata container #1 804 and in the metadata container #2 814, the index 824 was referenced to identify the corresponding container objects 828 containing the segments 806 812 and 816-822, which generated the required list of valid data objects 866, which includes the object #1 868, the object #2 870, the object #3 872, and the object #4 874, which should be currently stored in the Azure object storage container ABC 830.

The recovery process application 1102 verifies that the deleted Azure object storage container ABC 830 exists as the soft-deleted container 860 in the soft deleted entities 854. The recovery process application 1102 invokes an undelete operation 1104, which may be referred to as an undelete container operation, which restores 1106 the Azure object storage container ABC 830 and its contents to the same state as at the time of deletion. The recovery process application 1102 can invoke a list objects operation to identify if the object #1 868 and the object #4 874 which should be stored in the restored Azure object storage container ABC 830 are currently present in the restored Azure object storage container ABC 830. If the list of valid data objects 866 generated from the metadata from local volumes matches with the objects in the restored Azure object storage container ABC 830, that implies no objects were deleted from the Azure object storage container ABC 830 prior to its deletion.

In this example, a list objects operation succeeds for the object #1 868, the object #2 870, the object #3 872, and the object #4 874. The list of valid data objects 866 generated from the metadata included the object #1 868, the object #2 870, the object #3 872, and the object #4 874., and therefore now collectively matches with the list of the scanned object #1 through the scanned object #4 currently in the Azure object storage container ABC 830, and the file system integrity check can now be performed. Once that completes, the file system can come up on the backup and restore application 1108, thereby completing the recovery process. FIG. 11 depicts the elements 802-874, which are substantially similar to the elements 802-874 depicted in FIG. 8,

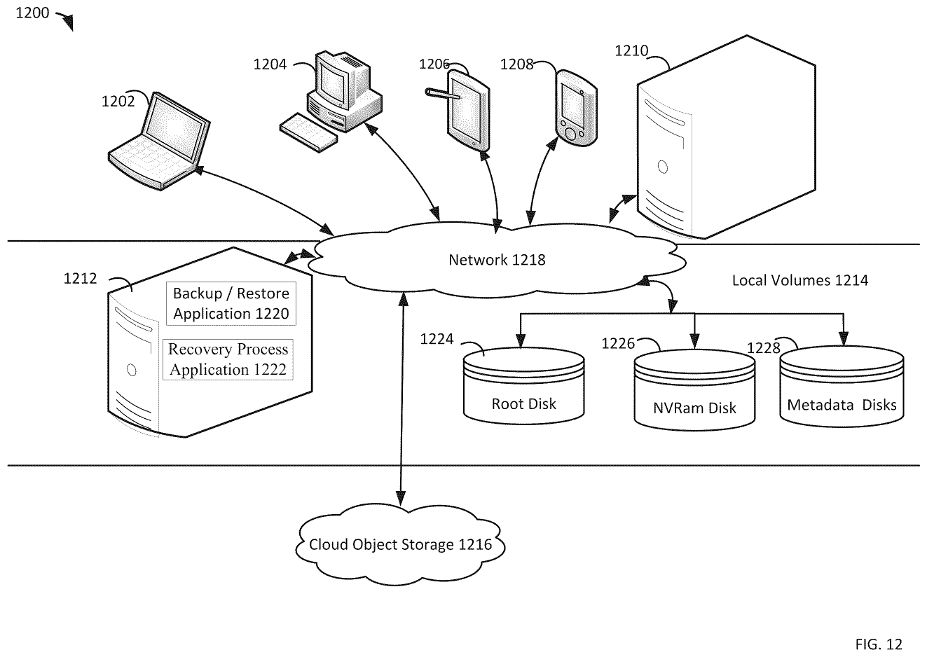

FIG. 12 illustrates a diagram of a system 1200 for restoring soft-deleted cloud objects which store deduplicated backup data. As shown in FIG. 12, the system 1200 may illustrate a cloud computing environment in which data, applications, services, and other application resources are stored and delivered through shared data centers and appear as a single point of access for the users. The system 1200 may also represent any other type of distributed computer network environment in which servers control the storage and distribution of application resources and services for different client users.

In an embodiment, the system 1200 represents a cloud computing system that includes a first client 1202, a second client 1204, a third client 1206; a fourth client 1208; a fifth client 1210, and a data protection server 1212. The first client 1202 may be a laptop computer 1202, the second client 1204 may be a desktop computer 1204, the third client 1206 may be a tablet computer 1206, the fourth client 1208 may be a smart phone 1208, and the fifth client 1210 may be a server 1210. The clients 1202-1210, the data protection server 1212, local volumes 1214, and a cloud object storage 1216 communicate via a network 1218. The data protection server 1212 includes a backup/restore application 1220 and a recovery process application 1222, and the local volumes 1214 include a root disk 1224, a NVRam disk 1226, and metadata disks 1228.

The backup/restore application 1220, such as Dell's Data Domain Virtual Edition, may include different policies for various data protection levels, such as a “gold” policy for VMware® clients, a “platinum” policy for UNIX® clients, and a “silver” policy for Windows® clients. The gold policy can specify to store 2 backup copies for each VMware® client's application resources onto the first disk for 6 months, store a primary clone of the backup copies onto the second disk for 1 year, and store a secondary clone of the backup copies onto a tape, for 5 years. In another example, a policy can provide redundancy by specifying to replicate each full backup copy to three different backups servers, replicate each incremental cumulative backup copy and each incremental differential backup copy to two different backup servers, replicate each archive log backup copy to one additional backup server, and relocate each full backup copy created at the end of the month to cloud tiering for long term retention. Backup copies stored in the cloud tiering have higher costs associated with storing and accessing the data in the backup copies. A policy's start time can specify the start times for creating a backup copy of an application resource, such as 12:00, 13:00, 14:00, and 15:00, for an hourly backup copy, a policy's retention policy can specify the length of time that a backup copy is retained before the backup copy is destroyed, such as a week, a month, or a year, and a policy's destination pool can include the target storage device where backup copies are stored.

The recovery process may begin when the recovery process application 1222 invokes a list object operation to identify if the objects which should be stored in the container are currently present in the container. Then the recovery process application 1222 compares the list of the valid data objects which should be in the container against the list of the objects which the list object operation identified as currently in the container, which provides the list of any missing objects. Following the identification of any missing objects, the recovery process application 1222 verifies that any missing objects and/or missing container continue to exist as soft deleted entities before invoking an undelete operation on the soft delete entities to restore any missing objects and/or a missing container.

Having prepared to undelete a container and/or its objects, the recovery process application 1222 invokes an undelete operation which restores a container and its contents to the same state as at the time of deletion, then the recovery process application 1222 invokes an undelete operation for any objects which are still missing, which restores the objects. During the undelete operations, the recovery process application 1222 takes precautions to prevent the undelete operations from applying to any objects which were intentionally deleted by a garbage collector. Finally, the recovery process application 1222 executes a file system integrity check to verify that no additional problems remain in the file system following the recovery from any unauthorized deletions.

FIG. 12 depicts system 1200 with five clients 1202-1210, one server 1212, one set of local volumes 1214, one cloud object storage 1216, one network 1218, one backup/restore application 1220, and one recovery process 1222, and three local volumes 1224-1228. However, the system 1200 may include any number of each of the clients 1202-1210, the server 1212, the set of local volumes 1214, the cloud object storage 1216, the network 1218, the backup/restore application 1220, the recovery process application 1222, and each of the local volumes 1224-1228.

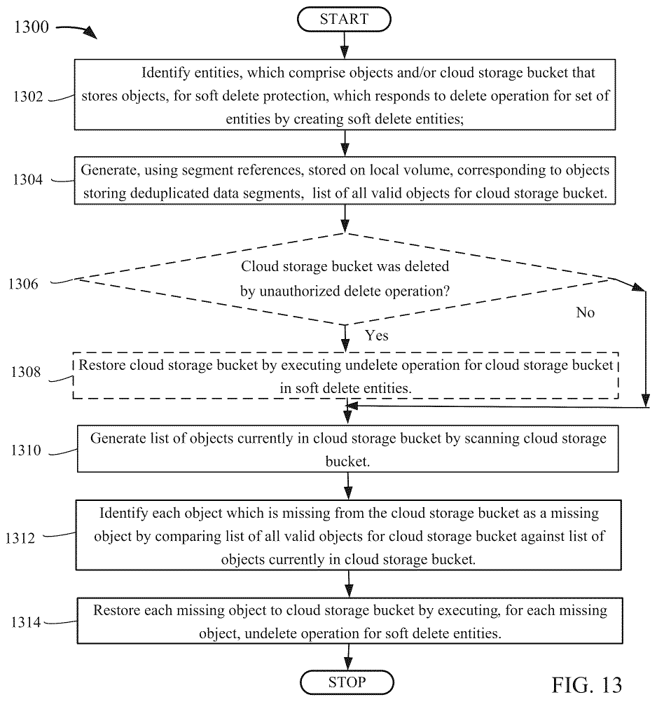

FIG. 13 is a flowchart that illustrates an example method which restores soft-deleted cloud objects which store deduplicated backup data, under an embodiment. Flowchart 1300 depicts method acts illustrated as flowchart blocks for certain steps involving the clients 1202 1210, the data protection server 1212, the local volumes 1214, the cloud object storage 1216, and the network 1218, of FIG. 12.

Entities, which comprise objects and/or a cloud storage bucket that stores the objects, are identified for soft delete protection, which responds to a delete operation for a set of the entities by creating soft delete entities, block 1302. A system enables soft deletions of specified data objects and cloud storage buckets that store data objects. For example, and without limitation, this can include the file system identifying the selections of the object #1 532, the object #2 534, the object #3 536, the object #4 538, and the Azure object storage container ABC 530 for soft delete protection, which subsequently responds to the unauthorized delete operations 542 and 544 for the object #2 534 and the object #4 538 in the Azure object storage container ABC 530, thereby creating the soft-deleted object #2 550 and the soft-deleted object #4 552 in the soft-deleted entities 554.

After a number of entities are identified for soft delete protection, the soft delete protection responds to a delete operation for a number of entities in a set of the identified entities by creating a number of soft delete entities, and the relationship between these numbers of entities may vary considerably. In the preceding example, 4 objects and 1 container are 5 entities which are identified for soft delete protection, which responds to a delete operation for 2 of the 5 identified entities, which are 2 of the objects, by creating the 2 soft delete entities, which are 2 soft-deleted objects, thereby resulting in applying the delete operation to 2 of 5(40%) soft protected entities and soft-deleting 2 of 5(40%) protected entities. In a typical real-world example, 1,000 entities may be identified for soft delete protection, which responds to a delete operation for only 1 of the 1,000 identified entities by creating 1 soft delete entity, which is the 1soft-deleted object, thereby resulting in applying the delete operation to 1 of 1,000(0.1%) protected entities and soft-deleting 1 of 1,000(0.1%) protected entities. In an example described above in reference to FIG. 11, 1 container that includes 4 objects are 5 entities which are identified for soft delete protection, which responds to a delete operation for 1 of the 5 identified entities, which is the 1 container, by creating 5 soft delete entities, which are the 1 soft-deleted container and its 4 soft-deleted objects, which results in applying the delete operation to 1 of 5 (20%) protected entities and soft-deleting 5 of 5(100%) protected entities.

An entity can be a distinct, identifiable object or concept about which information is stored and managed. An object can be a unit of computer storage that contains a value or group of values. A cloud storage bucket can be a container used to store and organize objects (files or data) within a network of remote servers which offer scalability and accessibility from anywhere.

Soft delete protection can be the enabling of a record to be as inactive or deleted without physically removing it from a database or storage, thereby allowing for potential recovery or auditing. A delete operation can be the act of removing data, files, or objects from a computer system's storage or memory. A set can be a group or collection of things that belong together or resemble one another or are usually found together. A soft delete entity can be a record that is marked as inactive or deleted without physically removing it from a database or storage, thereby allowing for potential recovery or auditing.

Each soft delete entity may be retained after soft deletion for restoration until a corresponding retention period expires. For example, an object that has been soft deleted may be restored within 30 days of the soft deletion. A soft deletion can be the act of marking a record as inactive or deleted without physically removing it from a database or storage, thereby allowing for potential recovery or auditing. A restoration can be the process of reverting a system or data to a previous state, usually after a problem or failure, by using a backup or restore point. A retention period can be the duration that a computer keeps a record before the record is destroyed.

After identifying entities for soft delete protection, segment references stored on a local volume, which correspond to objects storing deduplicated data segments, are used to generate a list of all valid objects for a cloud storage bucket, block 1304. The system uses local metadata to identify data objects that should be in a cloud storage bucket. By way of example and without limitation, this can include the file system using segment references metadata, stored on local volumes, which corresponds to the object #1 532, the object #2 534, the object #3 536, and the object #4 538 storing deduplicated data segments A, B, C, D, E, F, and G, to generate a list of all the valid objects 556, which includes the object #1 558, the object #2 560, the object #3 562, and the object #4 564, corresponding to the Azure object storage container ABC 530.

A segment reference can be metadata about a data object. A local volume can be a storage area, typically a hard drive or solid state disk, which is directly connected to and accessible by a single computer, as opposed to a network or cloud-based storage. A deduplicated data segment can be a unique portion of information that has been identified and stored only once, even if multiple instances of the same information exist, thus optimizing storage space and reducing redundancy. A list can be a data structure that stores a finite, ordered collection of items. A valid object can be a unit of computer storage that contains a value or group of values, and which is authorized for use.

Following the identification of all objects that should be in a cloud storage bucket, a determination is optionally made whether the cloud storage bucket was deleted by an unauthorized delete operation, block 1306. The system can determine whether the cloud storage bucket which should be storing the identified objects has been deleted. In embodiments, this can include the recovery process application 902 identifying the missing Azure object storage container ABC 830 and confirming its deletion by verifying that the deleted Azure object storage container ABC 830 exists as the soft-deleted container 860 in the soft deleted entities 854. In another example, the recovery process application 1102 verifies that the deleted Azure object storage container ABC 830 exists as the soft-deleted container 860 in the soft deleted entities 854. An unauthorized delete operation can be the unapproved act of removing data, files, or objects from a computer system's storage or memory.

If a cloud storage bucket was deleted by an unauthorized delete operation, the method 1300 continues to block 1308 to restore the deleted cloud storage bucket. If a cloud storage bucket was not deleted by an unauthorized delete operation, the method 1300 proceeds to block 1310 to identify which objects are currently in the cloud storage bucket.

If a cloud storage bucket was deleted by an unauthorized delete operation, then the cloud storage bucket is optionally restored by executing an undelete operation for the cloud storage bucket in the soft delete entities, block 1308. The system restores any cloud storage buckets that were deleted without authorization. For example, and without limitation, this can include the recovery process application 902 invoking an undelete operation 904 which restores 906 the Azure object storage container ABC 830 and its contents to the same state as at the time of deletion. In another example, the recovery process application 1102 invokes an undelete operation 1104 which restores 1106 the Azure object storage container ABC 830 and its contents to the same state as at the time of deletion. An undelete operation can be the act of restoring data, files, or objects to a computer system's storage or memory after the data, files, or objects had been removed from the computer system's storage or memory.

Having identified what objects should be in a cloud storage bucket, a list is generated of objects currently in the cloud storage bucket by scanning the cloud storage bucket, block 1310. The system identifies which objects are currently stored in the cloud storage bucket for comparing with the objects that should be stored in the cloud storage bucket. By way of example and without limitation, this can include the file system generating a list of object #1 532 and the object #3 536 currently in the Azure object storage container ABC 530 by executing the list objects operation on the Azure object storage container ABC 530. In another example, a list object operation succeeds for the object #1 868 and the object #3 872, but fails for the previously deleted object #2 870 and the previously deleted object #4 874.

In yet another example, the recovery process application 1102 invokes a list object operation to identify if the objects #1 868-#4 874 which should be stored in the restored Azure object storage container ABC 830 are currently present in the restored Azure object storage container ABC 830. If the list of valid data objects 866 generated from the metadata from local volumes matches with the objects in the restored Azure object storage container ABC 830, that implies no objects were deleted from the Azure object storage container ABC 830 prior to its deletion. As demonstrated in these examples, scanning a cloud storage bucket may include invoking a list objects operation. A list objects operation can be an instruction to identify units of computer storage that contain values or group of values.

After identifying which objects are in the cloud storage bucket, each object which is missing from the cloud storage bucket is identified as a missing object by comparing the list of all valid objects for the cloud storage bucket against the list of objects currently in the cloud storage bucket, block 1312. The system identifies the missing objects from the objects that are in the cloud storage bucket compared to the objects that should be in the cloud storage bucket. In embodiments, this can include the file system identifying the object #2 568 and the object #4 570 which are missing from the list of objects currently in the Azure object storage container ABC 530. A missing object can be a unit of computer storage that contains a value or group of values, but which is not present or included where it is expected or supposed to be. In another example, the recovery process application 902 compares the list of the valid data objects 866 against the list of the objects for which list object operation failed, the previously deleted object #2 870 and the previously deleted object #4 874, and provides the list of the missing objects 908, which include the missing object #2 910 and the missing object #4 912.

Following the identification of missing objects, each missing object is restored to the cloud storage bucket by executing, for each missing object, an undelete operation for the soft delete entities, block 1314. The system restores the objects which were deleted without authorization to the cloud storage bucket. For example, and without limitation, this can include the recovery process application 602 executing the undelete operations 604 and 608 on the soft-deleted entities for the object #2 606 and the object #4 610, which restores the previously missing object #2 626 and the previously missing object #4 632 to the Azure object storage container ABC 628.

In another example, the recovery process application 902 invokes an undelete operation 1002 for the object #2 850 and an undelete operation 1004 for the object #4 852, which were valid file system objects that had been previously deleted and are present in the list of soft deleted entities 854. The undelete operation 1002, which may be referred to as an undelete object operation, results in the restore 1016 of the object #2 834 in the Azure object storage container ABC 830, and the undelete operation 1004, which may be referred to as an undelete object operation, results in the restore 1018 of the object #4 838 in the Azure object storage container ABC 830, which already stores the object #1 832 and the object #3 836. Now the backup and restore application 1020 can succeed using the list objects operation for the object #2 834 and the object #4 838. Executing the undelete operation for a missing object can be based on a verification that the missing object has been soft-deleted. For example, after determining that the object #2 834 is supposed to be in the Azure object storage container ABC 830, but is currently missing from the Azure object storage container ABC 830, the recovery process application 902 verifies that the soft delete entities 854 stores the object #2 850 before invoking the undelete operation 1002 on the soft delete entities 854 to restore the object #2 850. A verification can be the process of establishing the truth, accuracy, or validity of something.

Restoring each missing object to a cloud storage bucket may exclude restoring any object which was intentionally deleted by a garbage collector. For example, when executing the undelete operation 604 on the soft-deleted entities for the object #2 606, and the undelete operations 608 on the soft-deleted entities for the object #4 610, the recovery process application 602 takes precautions to prevent the undelete operations from applying to the object #9 614 and the object #12 616, which were intentionally deleted 618 and 620 by the garbage collector 622. A garbage collector can be a form of automatic memory management that reclaims memory occupied by objects that are no longer in use by a program, preventing memory leaks and ensuring efficient resource utilization.

Restoring each missing object to a cloud storage bucket may include subsequently executing a file system integrity check. For example, after restoring the deleted object #2 606 and the deleted object #4 610, the recovery process application 602 executes a file system integrity check to verify that no additional problems remain in the file system following the recovery from the unauthorized deletions. A file system integrity check can be security processes that verify the trustworthiness of named collections of data and directories by comparing their current state to a known, trusted baseline, and detecting any unauthorized modifications or corruption.

Although FIG. 13 depicts the blocks 1302-1314 occurring in a specific order, the blocks 1302-1314 may occur in another order. In other implementations, each of the blocks 1302-1314 may also be executed in combination with other blocks and/or some blocks may be divided into a different set of blocks.

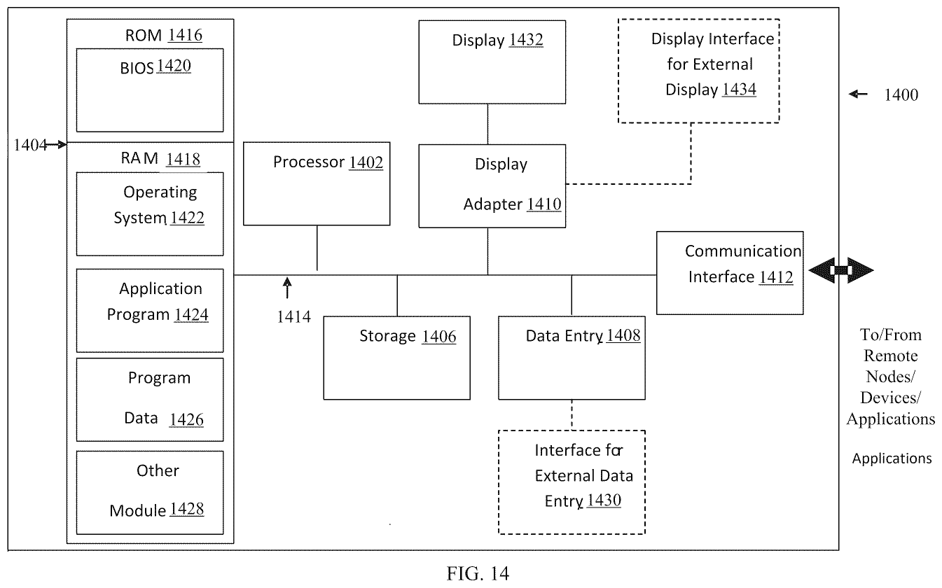

Having described the subject matter in detail, an exemplary hardware device in which the subject matter may be implemented shall be described. Those of ordinary skill in the art will appreciate that the elements illustrated in FIG. 14 may vary depending on the system implementation. With reference to FIG. 14, an exemplary system for implementing the subject matter disclosed herein includes a hardware device 1400, including a processing unit 1402, memory 1404, storage 1406, a data entry module 1408, a display adapter 1410, a communication interface 1412, and a bus 1414 that couples the elements 1404-1412 to the processing unit 1402.

The bus 1414 may comprise any type of bus architecture. Examples include a memory bus, a peripheral bus, a local bus, etc. The processing unit 1402 is an instruction execution machine, apparatus, or device and may comprise a microprocessor, a digital signal processor, a graphics processing unit, an application specific integrated circuit (ASIC), a field programmable gate array (FPGA), etc. The processing unit 1402 may be configured to execute program instructions stored in the memory 1404 and/or the storage 1406 and/or received via the data entry module 1408.

The memory 1404 may include read only memory (ROM) 1416 and random-access memory (RAM) 1418. The memory 1404 may be configured to store program instructions and data during operation of the hardware device 1400. In various embodiments, the memory 1404 may include any of a variety of memory technologies such as static random-access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example.

The memory 1404 may also include nonvolatile memory technologies such as nonvolatile flash RAM (NVRAM) or ROM. In some embodiments, it is contemplated that the memory 1404 may include a combination of technologies such as the foregoing, as well as other technologies not specifically mentioned. When the subject matter is implemented in a computer system, a basic input/output system (BIOS) 1420, containing the basic routines that help to transfer information between elements within the computer system, such as during start-up, is stored in the ROM 1416.

The storage 1406 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD, or other optical media. The drives and their associated computer-readable media provide nonvolatile storage of computer readable instructions, data structures, program modules and other data for the hardware device 1400. It is noted that the methods described herein may be embodied in executable instructions stored in a computer readable medium for use by or in connection with an instruction execution machine, apparatus, or device, such as a computer-based or processor-containing machine, apparatus, or device.

It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for conducting the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high-definition DVD (HD-DVD™), a BLU-RAY disc; and the like.

A number of program modules may be stored on the storage 1406, the ROM 1416 or the RAM 1418, including an operating system 1422, one or more applications programs 1424, program data 1426, and other program modules 1428. A user may enter commands and information into the hardware device 1400 through the data entry module 1408. The data entry module 1408 may include mechanisms such as a keyboard, a touch screen, a pointing device, etc. Other external input devices (not shown) are connected to the hardware device 1400 via an external data entry interface 1430.

By way of example and not limitation, external input devices may include a microphone, joystick, game pad, satellite dish, scanner, or the like. In some embodiments, external input devices may include video or audio input devices such as a video camera, a still camera, etc. The data entry module 1408 may be configured to receive input from one or more users of the hardware device 1400 and to deliver such input to the processing unit 1402 and/or the memory 1404 via the bus 1414.

A display 1432 is also connected to the bus 1414 via the display adapter 1410. The display 1432 may be configured to display output of the hardware device 1400 to one or more users. In some embodiments, a given device such as a touch screen, for example, may function as both the data entry module 1408 and the display 1432. External display devices may also be connected to the bus 1414 via an external display interface 1434. Other peripheral output devices, not shown, such as speakers and printers, may be connected to the hardware device 1400.

The hardware device 1400 may operate in a networked environment using logical connections to one or more remote nodes (not shown) via the communication interface 1412. The remote node may be another computer, a server, a router, a peer device, or other common network node, and typically includes many or all the elements described above relative to the hardware device 1400. The communication interface 1412 may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network).

Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, the communication interface 1412 may include logic configured to support direct memory access (DMA) transfers between the memory 1404 and other devices.

In a networked environment, program modules depicted relative to the hardware device 1400, or portions thereof, may be stored in a remote storage device, such as, for example, on a server. It will be appreciated that other hardware and/or software to establish a communications link between the hardware device 1400 and other devices may be used.

The arrangement of the hardware device 1400 illustrated in FIG. 14 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) may be realized, in whole or in part, by at least some of the components illustrated in the arrangement of the hardware device 1400.

In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 14.

Other components may be implemented in software, hardware, or a combination of software and hardware. Moreover, some or all these other components may be combined, some may be omitted altogether, and additional components may be added while still achieving the functionality described herein. Thus, the subject matter described herein may be embodied in many different variations, and all such variations are contemplated to be within the scope of what is claimed.

In the description herein, the subject matter is described with reference to acts and symbolic representations of operations that are performed by one or more devices, unless indicated otherwise. As such, it is understood that such acts and operations, which are at times referred to as being computer-executed, include the manipulation by the processing unit in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have properties defined by the format of the data. However, while the subject matter is described in this context, it is not meant to be limiting as those of skill in the art will appreciate that various of the acts and operations described herein may also be implemented in hardware.

To facilitate an understanding of the subject matter described, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation to encompass all such modifications and similar arrangements.

What is claimed is:

1. A system for restoring soft-deleted cloud objects which store deduplicated backup data, comprising:
one or more processors; and
a non-transitory computer readable medium storing a plurality of instructions, which when executed, cause the one or more processors to:
identify entities, which comprise at least one of objects or a cloud storage bucket that stores the objects, for soft delete protection, which responds to a delete operation for a set of the entities by creating soft delete entities;
generate, using segment references, stored on a local volume, corresponding to objects storing deduplicated data segments, a list of all valid objects for the cloud storage bucket;
generate a list of objects currently in the cloud storage bucket by scanning the cloud storage bucket;
identify each object which is missing from the cloud storage bucket as a missing object by comparing the list of all valid objects for the cloud storage bucket against the list of objects currently in the cloud storage bucket; and
restore each missing object to the cloud storage bucket by executing, for each missing object, an undelete operation for the soft delete entities.

2. The system of claim 1, wherein the plurality of instructions, when executed, will further cause the one or more processors to restore the cloud storage bucket by executing an undelete operation for the cloud storage bucket in the soft delete entities, in response to a determination that the cloud storage bucket was deleted by an unauthorized delete operation.

3. The system of claim 1, wherein each soft delete entity is retained after soft deletion for restoration until a corresponding retention period expires.

4. The system of claim 1, wherein executing the undelete operation for a missing object is based on a verification that the missing object has been soft-deleted.

5. The system of claim 1, wherein restoring each missing object to the cloud storage bucket excludes restoring any object which was intentionally deleted by a garbage collector.

6. The system of claim 1, wherein restoring each missing object to the cloud storage bucket comprises subsequently executing a file system integrity check.

7. The system of claim 1, wherein scanning a cloud storage bucket comprises invoking a list objects operation.

8. A computer-implemented method for restoring soft-deleted cloud objects which store deduplicated backup data, comprising:
identifying entities, which comprise at least one of objects or a cloud storage bucket that stores the objects, for soft delete protection, which responds to a delete operation for a set of the entities by creating soft delete entities;
generating, using segment references, stored on a local volume, corresponding to objects storing deduplicated data segments, a list of all valid objects for the cloud storage bucket;
generating a list of objects currently in the cloud storage bucket by scanning the cloud storage bucket;
identifying each object which is missing from the cloud storage bucket as a missing object by comparing the list of all valid objects for the cloud storage bucket against the list of objects currently in the cloud storage bucket; and
restoring each missing object to the cloud storage bucket by executing, for each missing object, an undelete operation for the soft delete entities.

9. The computer-implemented method of claim 8, wherein the computer-implemented method further comprises restoring the cloud storage bucket by executing an undelete operation for the cloud storage bucket in the soft delete entities, in response to a determination that the cloud storage bucket was deleted by an unauthorized delete operation.

10. The computer-implemented method of claim 8, wherein each soft delete entity is retained after soft deletion for restoration until a corresponding retention period expires.

11. The computer-implemented method of claim 8, wherein executing the undelete operation for a missing object is based on a verification that the missing object has been soft-deleted.

12. The computer-implemented method of claim 8, wherein restoring each missing object to the cloud storage bucket excludes restoring any object which was intentionally deleted by a garbage collector.

13. The computer-implemented method of claim 8, wherein restoring each missing object to the cloud storage bucket comprises subsequently executing a file system integrity check.

14. The computer-implemented method of claim 8, wherein scanning a cloud storage bucket comprises invoking a list objects operation.

15. A computer program product, comprising a non-transitory computer-readable medium having a computer-readable program code embodied therein to be executed by one or more processors, the program code including instructions to:
identify entities, which comprise at least one of objects or a cloud storage bucket that stores the objects, for soft delete protection, which responds to a delete operation for a set of the entities by creating soft delete entities;
generate, using segment references, stored on a local volume, corresponding to objects storing deduplicated data segments, a list of all valid objects for the cloud storage bucket;
generate a list of objects currently in the cloud storage bucket by scanning the cloud storage bucket;
identify each object which is missing from the cloud storage bucket as a missing object by comparing the list of all valid objects for the cloud storage bucket against the list of objects currently in the cloud storage bucket; and
restore each missing object to the cloud storage bucket by executing, for each missing object, an undelete operation for the soft delete entities.

16. The computer program product of claim 15, wherein the program code includes further instructions to restore the cloud storage bucket by executing an undelete operation for the cloud storage bucket in the soft delete entities, in response to a determination that the cloud storage bucket was deleted by an unauthorized delete operation.

17. The computer program product of claim 15, wherein each soft delete entity is retained after soft deletion for restoration until a corresponding retention period expires.

18. The computer program product of claim 15, wherein executing the undelete object for a missing object is based on a verification that the missing object has been soft-deleted.

19. The computer program product of claim 15, wherein restoring each missing object to the cloud storage bucket comprises subsequently executing a file system integrity check and excludes restoring any object which was intentionally deleted by a garbage collector.

20. The computer program product of claim 15, wherein scanning a cloud storage bucket comprises invoking a list objects operation.
